(19) United States
(12) Patent Application Publication
(10) Pub. No.: US 2026/0095230 A1
(43) Pub. Date: Apr. 2, 2026

(54) WIDE AND NARROW SATELLITE BEAMS BASED NTN SYSTEMS

(71) Applicant: InterDigital Patent Holdings, Inc., Wilmington, DE (US)

(72) Inventors: Umer Salim, Vallauris (FR); Moon IL Lee, Melville, NY (US); Brian Martin, Farnham (GB); Dylan Watts, Montreal (CA); Keiichi Kubota, Setagaya-ku (JP)

(73) Assignee: InterDigital Patent Holdings, Inc., Wilmington, DE (US)

(21) Appl. No.: 18/902,659

(22) Filed: Sep. 30, 2024

(51) Int. Cl. H04B 7/06; H04B 7/185; H04W 74/0833

(52) U.S. Cl. CPC H04B 7/0695; H04B 7/18513; H04W 74/0833

(57) ABSTRACT

In one method, a wireless transmit receive unit (WTRU) receives a SSB and/or one or more SIBs through a wide beam from a non-terrestrial network (NTN) satellite. The decoded SIBs may provide a set of reference locations for narrow beams and several RACH configurations (or SSB-to-RACH occasion (RO) mappings) for narrow beams provided against reference timings and satellite location. The WTRU determines a suitable RACH resource based upon one or more of (i) WTRU location, (ii) reference locations for narrow beams, (iii) current time, (iii) reference timings for RACH configurations (or SSB-RO mappings) and (iv) satellite location. The WTRU transmits RACH over the determined RACH resource. In some embodiments the SIBs are received in a narrow beam based on SSB MIB information. In other embodiments, a narrow beam is selected based on CSI-RS measurements

### BACKGROUND

A non-terrestrial network (NTN) satellite can support multiple cells, where each cell consists of one or more satellite beams. Satellite beams cover a footprint on earth (like a terrestrial cell) and can range in diameter from 100- 1000 km in non-geostationary orbit (NGSO) deployments, and 200- 3500 km diameter in GSO deployments. Beam footprints in GSO deployments remain fixed relative to earth, and in NGSO deployments the area covered by a beam/cell changes over time due to satellite movement. This beam movement can be classified as “earth moving” where the NGSO beam moves continuously across the earth, or “earth fixed” where the beam is steered to remain covering a fixed location until a new cell overtakes the coverage area in a discrete and coordinated change.

Satellite operators can use wide beams for common downlink (DL) signals and channel transmissions (e.g., synchronized signal block (SSB) and/or system information blocks (SIBs). Narrow beams, within the wide beam coverage, may be used for user equipment (UE) dedicated channels. With wide beams, the overhead of common channel transmissions reduces. For example, if a wide beam spans four narrow beams, the overhead of common channels transmission reduces by four. If the UEs performing initial access transmit the random access channel (RACH) based upon the wide beam and the gNB has to detect/decode the RACH through a wide beam-based receiver, RACH reception will suffer significant coverage degradation (e.g., loss of beamforming gain), resulting in the UEs being unable to attach/camp. Solutions are required for the UEs/Network to be able to identify a suitable narrow beam for RACH transmission/reception where UEs initially receive the SSB and/or SIBs through a wide beam.

### SUMMARY

Aspects of the present disclosure may provide improved performance and/or reduced overhead in NTNs. In a first aspect, a UE, alternatively referred to herein as a wireless transmit receive unit (WTRU), receives a SSB and/or one or more SIBs through a wide beam. In one example, the decoded SIBs may provide a set of reference locations for narrow beams and several RACH configurations (or SSB-to-RACH occasion (RO) mappings) for narrow beams provided against reference timings and satellite location. The WTRU may determine a suitable RACH resource based upon one or a combination of: (i) WTRU location, (ii) reference locations for narrow beams, (iii) current time, (iii) reference timings for RACH configurations (or SSB-RO mappings) and (iv) satellite location. Subsequently, the WTRU may send a RACH transmission over the determined RACH resource.

In some example aspects, a first beam carrying the SSB and a second beam carrying SIB(s) are a same wide beam from the satellite. In other example aspects, the first beam is a wide beam and the second beam is a narrow beam within coverage of the wide beam. In certain examples, the location of the WTRU is determined from a global network satellite system (GNSS).

In another example aspect, a WTRU detects the SSB of a wide beam from an NTN satellite, and based on the SSB, reads SIBs (e.g., SIB1/SIB19). In this example aspect, the SIB(s) provide channel state information reference signal (CSI-RS) resource configurations corresponding to the narrow beams within the wide beam and a CSI-RS narrow beam to RACH resource mapping. The WTRU measures the CSI-RS of narrow beams and selects a suitable narrow beam (e.g., with a highest reference signal received power (RSRP)). The WTRU determines a RACH resource associated with the selected CSI-RS narrow beam and sends a RACH transmission over the determined RACH resource.

In a further example aspect, a WTRU detects a SSB of the wide beam. The wide beam SSB may provide information of narrow beam CSI-RS resources and corresponding CORESET 0 configurations. The WTRU measures the CSI-RS of narrow beams and selects a suitable (e.g., highest RSRP) narrow beam. The WTRU reads SIBs (e.g., SIB1/SIB19) transmitted through the selected narrow beam, and based on the SIBs, the RACH configuration for the selected narrow beam. The WTRU may then send a RACH transmission over the selected narrow beam based on the received RACH configuration. Additional aspects, features or advantages may become apparent from the embodiment disclosed hereafter.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example scenario for beam deployment by a satellite in a non-terrestrial network (NTN);

FIG. 3 is a diagram illustrating an example of a wide beam and four narrow beams within coverage of the wide beam from an NTN satellite;

FIG. 4 is a flow diagram illustrating a method for a wireless transmit receive unit (WTRU) determination of a narrow beam for a random access channel (RACH) transmission based on location and time according to one example embodiment;

FIG. 5 is a flow diagram illustrating a method for a WTRU determining a narrow beam for a RACH transmission based on reference signal (RS) measurements according to another example embodiment; and

FIG. 6 is a flow diagram illustrating a method for a WTRU determining a narrow beam for a RACH transmission based on measurements of RSs with only a synchronization signal block (SSB) broadcast in a wide beam according to another example embodiment.

### DETAILED DESCRIPTION

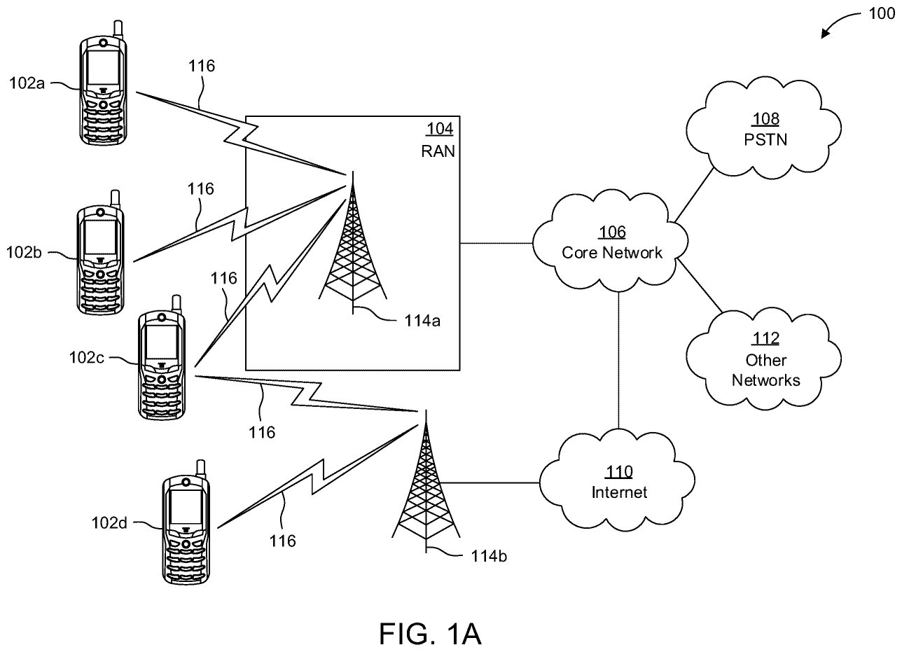

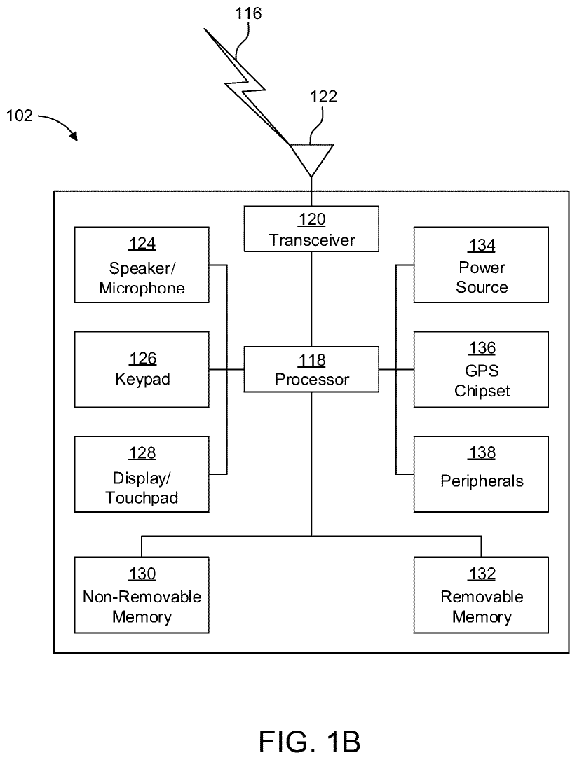

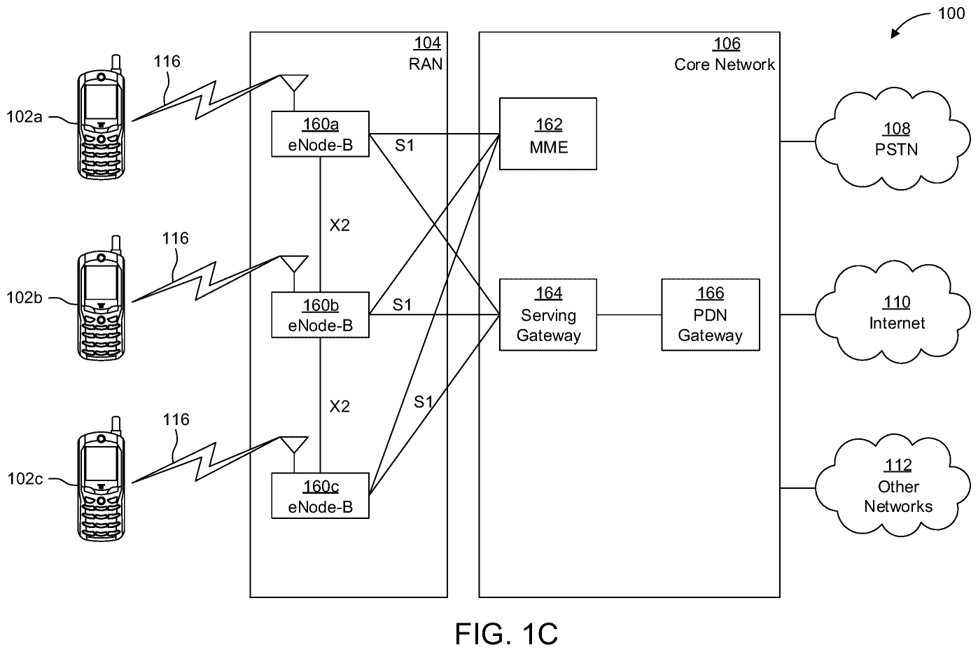

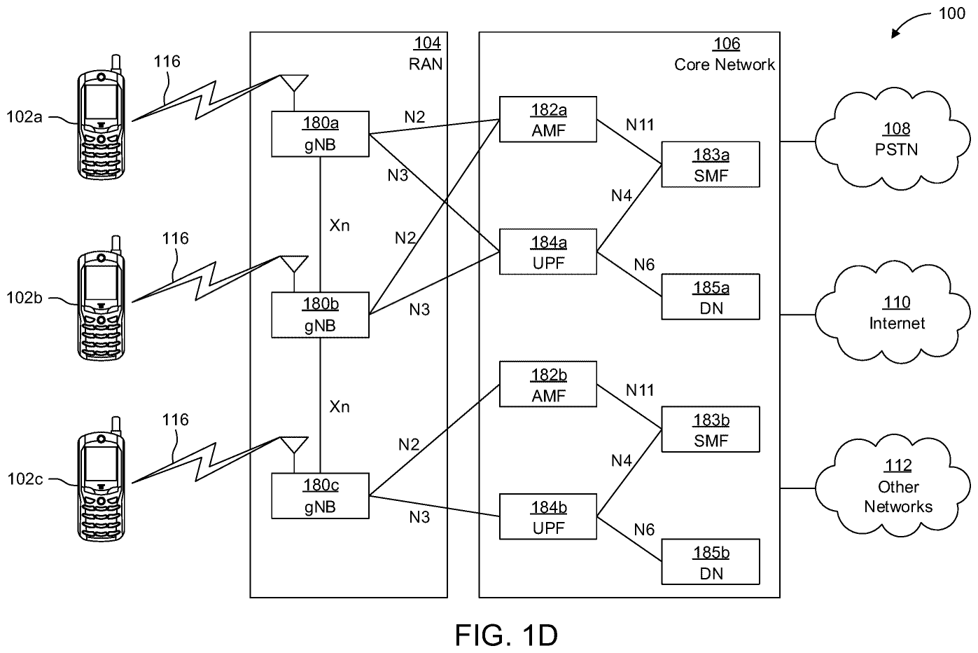

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11acinfrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ahrelative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Non-Terrestrial Networks (NTN) are now described. A basic NTN is an aerial or space-borne platform which, via a gateway (GW), transports signals from a land-based base station/gNB to a WTRU and vice-versa. Aerial or space-borne platforms are classified in terms of their orbit, with non-geosynchronous orbit (NGSO) satellites including low-earth orbit (LEO) with altitude range of 300- 1500 km and medium-earth orbit (MEO) satellites with altitude range 7000- 25000 km. NGSO satellites move continuously overhead relative to earth, whereas geosynchronous orbit (GSO) satellites remain fixed overhead by maintaining an altitude at 35786 km.

Satellite platforms are further classified as having a “transparent” or “regenerative” payload. Transparent satellite payloads implement frequency conversion and RF amplification in both the uplink and downlink, with multiple transparent satellites possibly connected to one land-based gNB. Regenerative satellite payloads may implement either a full gNB or gNB distributed unit (DU) onboard the satellite. Regenerative payloads may perform digital processing on the signal including demodulation, decoding, re-encoding, re-modulation and/or filtering.

An NTN satellite can support multiple cells, where each cell consists of one or more satellite beams. Satellite beams cover a footprint on earth (like a terrestrial cell) and can range in diameter from 100- 1000 km in NGSO deployments, and 200- 3500 km diameter in GSO deployments. The beam footprints in GSO deployments remain fixed relative to earth, and in NGSO deployments the area covered by a beam/cell changes over time due to satellite movement. This beam movement can be classified as “earth moving” where the NGSO beam moves continuously across the earth, or “earth fixed” where the beam is steered to remain covering a fixed location until a new cell overtakes the coverage area in a discrete and coordinated change.

Key challenges of non-terrestrial networks may include: 1) continuous movement of NGSO satellites overhead resulting in frequent and continuous cell change; 2) cell sizes up to 3500 km in diameter; and 3) round trip times (RTT) several orders of magnitude larger than terrestrial networks (i.e., up to 541.46 ms)

DL coverage enhancement has been a topic of discussion for new radio (NR) NTN Rel-19 with justification of offering optimized performance especially when addressing handset terminals (including smartphones with −5.5 dBi antenna gain) with respect to downlink coverage considering the NTN deployment constraints such as payload power limitation, large satellite foot print and limited feeder link bandwidth. DL coverage enhancements are needed to accommodate satellite payload constraints which may be unable to have all its beams active with a nominal effective isotropically radiated power (EIRP) density per beam at a given time due to limited power and limited feeder link bandwidth, while maximizing the number of beams that can be activated simultaneously, and ensuring that all user terminals can be served across the satellite footprint. DL coverage enhancements should also maximize the overall satellite throughput and ensure that all satellite's radio cells are kept alive, even without traffic, but allow new users to join or prevent impact on end-user QoS.

DL coverage enhancements can be considered at both the link and system levels. At the link level, a goal is to improve the link margin of selected physical channels in order to accommodate the EIRP reduction in frequency range 1 (FR1)-NTN. A link margin improvement for physical channels (e.g. PDSCH and PDCCH) may be considered without impact on SSB design. At the system level a goal is to support efficient dynamic and flexible power sharing between beams or different beam pattern/size (i.e., wide or narrow) across the satellite foot print for FR1-NTN and FR2-NTN.

Recent efforts include studying and specifying if there may be beneficial downlink coverage enhancements targeting support for additional reference satellite payload parameters covering both GSO and NGSO constellations operating in FR1-NTN or FR2-NTN (e.g., 3GPP RAN1, RAN2, RAN4). These efforts attempt to clarify the following objectives (1)-(3):
(1) Define additional reference satellite payload parameters assuming power sharing among satellite beams or different satellite beam patterns/size (i.e. wide or narrow) across the satellite footprint, such that satellite beams may not all be simultaneously active or may be active below the nominal EIRP density per satellite beam (see section 6.1.1 in TR 38.821) due to limited power and limited feeder link bandwidth.
(2) Define the corresponding power sharing assumptions and necessary link level and system level evaluation methodology and relevant KPIs for evaluations of the coverage, to allow for identification of physical channels/signals and system-level aspects that need enhancements and the corresponding needed improvements.
(3) Study, and if needed, specify solutions including link level enhancements for FR1-NTN (e.g. for physical downlink control channel (PDCCH) and physical downlink shared channel (PDSCH)) and/or system level enhancements for FR1-NTN and/or FR2-NTN, allowing dynamic and flexible power sharing between satellite beams or different satellite beam patterns/size (i.e. wide or narrow) across the satellite footprint.

A list of targeted physical channels/signals for link level enhancements, and with the targeted system-level enhancements are to be determined and backward compatibility for potential extension of the SSB periodicity is being considered, in conjunction with the targeted system-level enhancements.

Considerations for these objective may include:
SSB periodicity extension only applies to NTN operation;
WTRU's cell search complexity and impact to initial cell selection, latency and success rate;
Antenna gain of a WTRU shall be assumed to be −5.5 dBi in case of smartphone in FR1-NTN, the WTRU is assumed to be a full duplex WTRU, and at least 2Rx are considered at the WTRU;
NGSO to be considered in priority: LEO Set-1 @ 600 km; and
3GPP Rel-18 network energy saving techniques should be considered as baseline in a system level study.

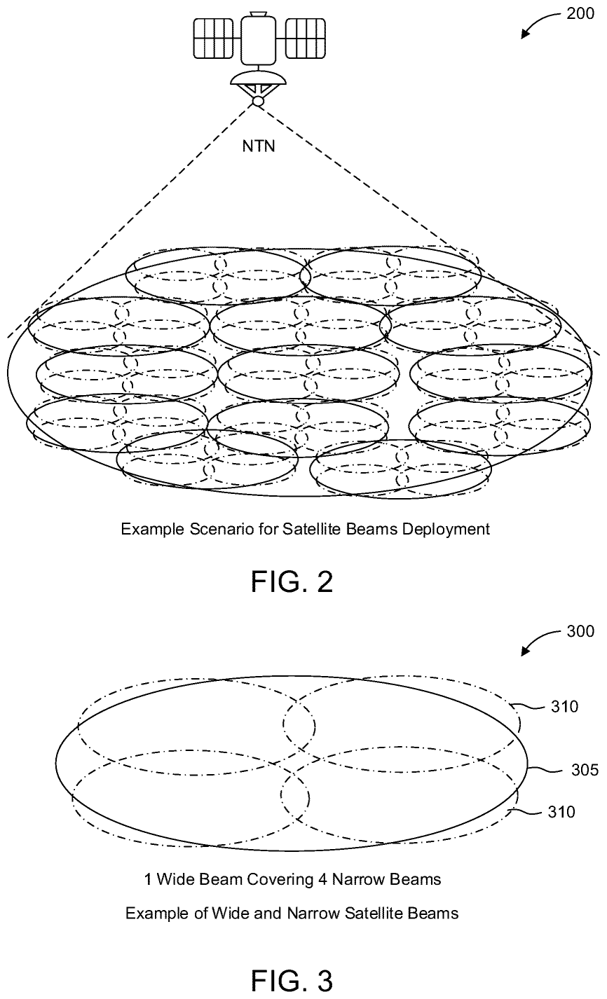

Referring to FIG. 2, diagram 200 shows an NTN satellite footprint including examples of satellite beam deployment. In one example, a LEO-600 NTN satellite may have coverage footprint of ˜1.8 million km2, equivalent to 1058 beams for a reference beam diameter of 50 km. The payload constraints in terms of available power, hardware (e.g., RF chains/antenna arrays) and feeder link capacity, may limit the number of active beams to 10%, 5%, or even 2.5%.

An NTN satellite capable of activating 2.5% of 1000 beams can illuminate 25 beams. Thus, one active beam (HW/RF chain/antenna array) needs to provide coverage for 1000/25=40 beam footprints through beam hopping. The fast beam hopping in narrow beams results in significant time/resource overhead for DL common channels transmission, given that the network has to do the periodic transmissions of SSB/SIBs throughout the satellite coverage.

Referring to FIG. 3 diagram 300, satellite operators can use a wide beam 305 for common DL channel transmissions (e.g., SSB and/or SIBs), and narrow beams 310 for WTRU dedicated channels. As previously mentioned, with wide beams, the overhead of common channel transmissions reduces. As shown in FIG. 3, wide beam 305 spans 4 narrow beams 310, the overhead of common channels transmission reduces by 4.

If the WTRUs performing initial access transmit a RACH based upon a wide beam and the NTN satellite/gNB has to detect/decode RACH transmissions through the wide beam based receiver, RACH reception will suffer significant coverage degradation, e.g., loss of beamforming gain, resulting in WTRUs which may be unable to attach/camp in the cell. In view of this, in NTN networks, should preferably use a narrow beam for RACH transmissions.

Embodiments disclosed herein may propose solutions for how the WTRUs/Network may identify a suitable narrow beam for RACH transmission/reception, where WTRUs receive the SSB and/or SIBs through a wide beam. In the solutions presented hereafter, various considerations are discussed. It should be recognized that while example embodiments are discussed in relation to NTN satellites, the solutions described herein are not limited to satellite transmissions and can be adapted to work with other communication entities on a high-altitude platform.

Receiving an SSB through a wide beam is now discussed. In various embodiments, a WTRU may receive an SSB through a first beam, e.g., a wide satellite beam. The WTRU may use the SSB reception to perform time and frequency synchronization with the cell/beam used to transmit SSB. Based upon the received SSB, the WTRU may determine to read SIB1 through a second beam, e.g., the same wide satellite beam. In an alternate design, the SSB received through the wide satellite beam may provide the WTRU an indication about the SIBs (e.g., SIB1 and SIB19 etc.) being transmitted by the network through a second beam that may be a single beam, or a set of beams. The second beams may correspond to a set of narrow satellite beams.

In one example, the SSB received through the first beam, e.g., the wide beam, which may provide the indication about the second beams, e.g., the narrow beams, within the coverage of the first beam. The indication transmitted by the first beam, about the second beam(s), may include information necessary for a WTRU to identify its suitable second (narrow) beam. In one example, the WTRU may determine its suitable second beam based upon the indication received through the SSB of the first beam prior to decoding system information. In another example, the WTRU may determine the second beam based upon the indication and the radio measurements, e.g., measurements made over suitable RS for which configuration is received through the wide beam.

In embodiments where a WTRU may receive the indication about the second (narrow) beams through an SSB received over the first beam, the WTRU may receive one or more of the following factors (1)-(5):
(1) A number of second (narrow) beams within the coverage of the first (wide) beam;
(2) A configuration (time/frequency/periodicity) of SSBs (e.g., cell defining SSB, or non-cell-defining SSBs) transmitted by the second beam(s);
(3) The configuration for CSI-RSs transmitted by the second beams (e.g., time, frequency, periodicity etc.);
(4) A configuration for any other suitable RS; and/or
(5) Any subset or all of the elements of “narrow beam configuration,” as disclosed in one or more of the embodiments in this disclosure.

In various embodiments, a WTRU may receive the indication about the second beams through a SSB received over the first beam. The SSB received over the first beam may be a cell defining SSB or a non-cell defining SSB. The SSB may carry the indication about the second beams through one or more of the following examples (1)-(6).
(1) PDCCH_config_SIB1 bits in a master information block (MIB): The PDCCH_config_SIB1 bits, carried in a MIB payload, may be used to carry the indication about the second beam(s). This may, for example, be the case when the first (wide) beam transmitting the SSB is not used to transmit SIB1 by the network. In one design, all bits for PDCCH_config_SIB1 are used to provide indication for the second beams. In another design, only partial bits, from PDCCH_config_SIB1 bits, are used to carry indication for the second beams.
(2) MIB information elements other than PDCCH_config_SIB1: The bits used to carry other information elements as MIB payload may be used to carry the indication about the second beams. This may be achieved, for example, when some of the information is already known to the WTRU, or by fixing some information for NTN systems employing wide and narrow beams, and thus re-purposing those information bits to transmit the indication about the second beams. In one example, if the second beam(s) transmit the SSB, or transmit a subset of the information carried in a SSB of the fist (wide) beam, many of the information elements in the SSB of the first beam may become redundant and may be used by the network to transmit the indication about the second beam(s).
(3) SSB index bits: The SSB index bits transmitted through a SSB may be used to transmit the indication about the second beam(s). The SSB index bits can be used to transmit the indication about the second beams partially or in full. The legacy 5G NR systems transmit SSB index bits as a physical broadcast channel (PBCH) payload and/or demodulation reference signal (DMRS) sequence initialization. Legacy systems may have up to 6-bits to transmit one of the SSB index among the 64 SSB indices. In lower frequencies, e.g., FR1 only 4 or 8 SSB beams may be employed. In that case, additional SSB bits beyond 2 or 3 may be used to carry the indication for second beams.
(4) New bits in a MIB payload: In one design, the SSB may carry the indication for second beams in the additional bits as part of the MIB payload.
(5) New bits in a PBCH payload: In one design, the SSB may carry the indication for second beams in the additional bits as part of the PBCH payload.
(6) New bits carried over a PBCH DMRS: In one design, the indication for second beams is carried over a PBCH DMRS. This may be achieved by transmitting the second indication, which is transmitted as one or more of the physical properties of the PBCH DMRS, e.g., DMRS sequence selection, phase/frequency/time/offset of the DMRS sequences, different initializations for PBCH DMRS carrying the information, etc.

In some embodiments, a WTRU receives one or more SIBs through the wide beam, i.e., the first beam and the second beam are the same wide satellite beam.

The WTRU may determine to read SIB1 through a beam, e.g., a wide beam, based upon the SSB indication received through the first beam (wide beam). The SSB detected and decoded through the wide satellite beam may provide the configuration to receive SIB1. This may, for example, be achieved by SSB providing the information of CORESET 0 configuration and search space 0 configuration through which the WTRU may receive SIB1 transmissions. Based upon received SIB1, the WTRU may determine how to decode or request additional SIB(s) (e.g., SIB19 etc.).

According to certain embodiments, the WTRU may determine to read SIB1 (and SIB19) through the wide beam based upon the SSB indication received through wide beam. The WTRU may determine one or more of the following factors (1)-(7) based upon its decoded SIB1:
(1) Cell selection information;
(2) Information regarding the availability and scheduling (e.g. periodicity, system information (SI)-window size) of other SIBs;
(3) An indication whether other SIBs are provided via periodic broadcast basis or only on-demand basis;
(4) Information for the WTRU to perform a SI request;
(5) A serving cell configuration (e.g., DL config, UL config [UL bandwidth part (BWP), RACH configuration etc.], SSB position in burst etc.);
(6) Timers and constants for WTRU procedures; and/or
(7) A narrow beam configuration, where the contents of the narrow beam configuration are according to any of the embodiments in this disclosure.

In the following embodiments, a satellite may transmit through wide and narrow satellite beams. In one design, the satellite may transmit one set of signals and channels through the wide satellite beam, and another set of signals and channels through the narrow satellite beam(s). The signals and channels transmitted through the wide beam may be one or more of the following:
SSB (or other reference signals serving to provide time and frequency synchronization for WTRUs);
SIB1 (carrying master information block, or the most basic part of system information, etc.);
SIBs (e.g., other than SIB1, or all SIBs, etc.);
Paging (e.g., all paging, or paging related to certain causes, e.g., SIB update, or related to emergency warning systems, etc.); and/or
All or a subset of common channels.

In various embodiments, a WTRU may transmit uplink signals and channels using a Tx filter which corresponds to the Rx filter used by the WTRU to receive the satellite's transmissions through the wide beam. Such uplink transmissions by the WTRU may correspond to any of a RACH msg 1, msg A, msg 3, PUCCH (e.g., for ACK/NAK, for scheduling request (SR), etc.), or any other signals/channels that a WTRU may transmit prior to determination of suitable narrow beam for its uplink transmissions.

A WTRU may detect and receive signals and channels transmitted through a wide satellite beam. The signals and channels received by the WTRU through the wide beam may be one or more of the following:
SSB (or other reference signals serving to provide time and frequency synchronization for WTRUs);
SIB1 (carrying master information block, or the most basic part of system information, etc.);
SIBs (e.g., other than SIB1, or all SIBs, etc.);
Paging (e.g., all paging, or paging related to certain causes, e.g., SIB update, or related to emergency warning systems, etc.); and/or
All or a subset of common channels.

Receiving configuration for narrow beams will now be described. According to various embodiments, a WTRU may receive one or more configurations for narrow beams. This may, for example, be the case when the transmission point is onboard a satellite. The satellite-based transmission may correspond to a transparent NTN architecture or a regenerative NTN architecture. The WTRU may receive the configuration for narrow beams when, for example, the network is using wide and narrow satellite beams.

According to various embodiments, the WTRU may determine the narrow beams configuration based upon one or more of the following:
a SSB received through a first beam, e.g., a wide beam;
a SIB1 received through a first beam, e.g., a wide beam;
a SIB19 received through a first beam, e.g., a wide beam;
Any SIB (e.g., through elements in a new SIB, updated SIB, or a re-purposed SIB) received through a first beam, e.g., a wide beam;
Common or dedicated signaling;
Pre-specified configurations (e.g., when one or more configurations or patterns are pre-defined and known to the WTRU); and/or
Universal subscriber identity module (USIM)-based information (e.g., when the WTRU gets the information through the USIM, where it may have been pre-configured, or downloaded later through the network, or through prior connection to the network).

The content of the configuration for narrow beams may be according to any one of the embodiments in this disclosure.

A WTRU may receive configuration for narrow beams. The configuration for narrow beams may be a single configuration or a set of narrow beams configurations. In one example design, the WTRU may receive a single configuration which provides the configuration for one or more narrow beams. In another example design, the WTRU may receive more than one configuration for narrow beams. This may, for example, be the case when there is one configuration for each narrow beam. Based upon one or more configurations for narrow beams, the WTRU may determine any one or more of the following information elements (1)-(5) for the narrow beams.
(1) Reference locations for narrow satellite beams: The WTRU may receive one or more reference locations which are representative of the narrow beams. In one design, the reference locations may correspond to the geographic coordinates of the narrow beam central location. In one design, the reference locations may be represented in any suitable units: e.g., through GNSS location parameters.
(2) One or several RACH configurations or SSB to RACH occasion (RO) mappings: The narrow beam configuration may include one or more RACH configurations or SSB-to-RO mappings. In one example design, the SSB corresponds to the SSB received through a wide satellite beam. In another design, the SSB corresponds to the SSB received through a narrow satellite beam. In another design, a suitable reference signal other than SSB may be associated to different ROs.

In the example embodiments, each SSB to RO mapping may be associated to any one or more of the following elements (A)-(E).
(A) Reference timings, where a set of reference timings are configured/provided with the SSB to RO mappings, and the WTRUs may be configured to select an SSB to RO mapping based upon their current time and reference timings. The current time may correspond to the system time, or system frame number, or another suitable time. The current time may be any of the time of the SSB detection, or the time of the SIB1 detection, or the time of the (potential/intended) RACH transmission. For example, the WTRUs may be configured to select a mapping based upon current time corresponding to one reference time, e.g., being closest. The relations between reference timings and SSB-to-RO mappings may be one to one, one to many, many to one, etc. The reference timings may be based upon earth fixed or earth moving cells. The reference timings may be defined at the level of narrow beams, or wide beams (e.g., the same timing will apply for all the narrow beams within a wide beam), or satellite (e.g., the same timings will apply to all the wide and narrow beams of the satellite). In one design, the reference timings may be defined based upon the service time of the satellite.
(B) Reference time ranges, where different time ranges are associated to one or more SSB to RO mappings. The WTRUs may be configured to select an SSB to RO mapping based upon their current time and reference time ranges, e.g., based upon current time being within a given time range. The current time may correspond to the system time, or system frame number (SFN), or another suitable time. The current time may be any of the time of the SSB detection, or the time of the SIB1 detection, or the time of the (potential/intended) RACH transmission. The relations between reference time range and SSB-to-RO mappings may be one to one, one to many, many to one, etc. The reference time ranges may be based upon earth fixed or earth moving cells. The reference time ranges may be defined at the level of narrow beams, or wide beams (e.g., the same timing will apply for all the narrow beams within a wide beam), or satellite (e.g., the same timings will apply to all the wide and narrow beams of the satellite). In one design, the reference time ranges may be defined based upon the service time of the satellite.
(C) Satellite location, where for example, one or more SSB to RO mappings are associated to one or more satellite locations.
(D) Satellite ephemeris data, where for example, one or more SSB to RO mappings are associated to one or more features/properties of satellite ephemeris data.
(E) Reference locations for narrow satellite beams.

In one example design, each single SSB to RO mapping may provide a set of RACH resources (e.g., RACH transmission occasions, RACH preambles, etc.), and an association of RACH resources to one or more of the following:
SSB indices detected through wide satellite beam;
SSB indices detected through narrow satellite beams;
Reference locations for narrow satellite beams;
CSI-RS of narrow satellite beams; and/or
Any suitable reference signals (RSs) associated to narrow satellite beams.

In one example design, there is only a single SSB to RO mapping.
(3) RS Configuration to identify narrow beams (for example, CSI-RS resource configurations or some other suitable RS configurations corresponding to the narrow beams within the wide beam)
(4) SSBs identifying narrow beams, e.g., cell defining SSBs or non-cell defining SSBs may be used to identify the narrow beams
(5) RACH resource mapping for narrow beams, e.g., a set of RACH resources are provided wherein the RACH resources may be associated to narrow satellite beams, either based upon reference locations of narrow beams, or based upon any suitable RS (e.g., CSI-RS) associated to the narrow beams.

WTRU determination of active DL/UL timings will now be explained. A WTRU may determine the active timings for the cells or satellite beams. The network may be using an energy saving mechanism at system level, cell level, or beam level. In an example, the WTRU may determine the active DL timings when the WTRU may receive the SSB/SIBs (e.g., SIB1, SIB19, etc.) through the satellite. The WTRU may determine the active UL timings when it is allowed to transmit UL transmissions (e.g., RACH transmissions, Msg1/3/A, etc.) to the network. The WTRU determination of active DL or UL time may be based upon WTRU knowledge of network energy saving mechanism. The WTRU determination of active DL or active UL timings may be based upon pre-configuration, configuration or network indication through any implicit or explicit mechanism.

Upon determining active DL timings, the WTRU may apply determined active times to receive DL signals/channels. Upon determining active UL timings, the WTRU may apply determined active times to transmit UL signals/channels.

In certain embodiments, determination of select narrow beam may be based upon WTRU location. Example WTRU determination of WTRU location may be based upon GNSS, or radio access technology (RAT)-based positioning, or based upon finger printing, or any suitable technology.

Determination of a WTRU location may be based upon global navigation satellite system (GNSS), or radio access technology (RAT)-dependent based positioning, e.g., Multi-RTT, time difference of arrival (TDOA), angle of arrival (AoA), or based upon finger printing, or any suitable technology.

Examples of WTRU determination of a suitable narrow beam are described. In one example, the WTRU can determine a suitable narrow beam from a set of indicated/configured narrow beams. The WTRU can determine a suitable narrow beam based upon any one or more of a WTRU location or reference location for the narrow beams

In one design, the WTRU may determine a suitable narrow beam whose reference location is closest to the WTRU's own determined location. This may for example be the case when the WTRU has the knowledge of the reference locations for one or more narrow beams.

In one design, the WTRU may determine a suitable narrow beam whose coverage area includes the WTRU's own determined location. This may for example be the case when the WTRU knows the coverage areas for one or more narrow beams.

Certain embodiments utilize WTRU measurements over reference signals (RSs) transmitted through narrow beams. In an example, a WTRU can make measurements over several reference signals (RSs) configurations associated to narrow beams. The WTRU can determine the configuration for narrow beams based upon the description of any one or more of the embodiments described herein.

In certain embodiments, the WTRU receives the narrow beams configuration through the SSB of a first beam, e.g., a wide beam. This may for example be the case when WTRU is configured to measure several RS transmitted by the network over the second beams, e.g., narrow beam, and determine a suitable narrow beam for DL reception and UL transmission.

In one embodiment, the WTRU may receive the narrow beams configuration through system information (e.g., SIB1, etc.) received over the first beam, e.g., the wide beam. Based upon the information received through SIB1, the WTRU makes measurements over several CSI-RS resources corresponding to narrow beams, and selects a suitable narrow beam (e.g., based on a highest RSRP, RSRQ, or other signal quality indicator).

Example determination of a suitable narrow beam based upon measurements is described. A WTRU can determine a suitable second beam, e.g., a suitable narrow beam. The WTRU can select a suitable narrow beam from a set of indicated/configured narrow beams based upon measurements made over several RS configurations associated to several narrow beams.

In one design, the WTRU can select the narrow beam for which WTRU measurements have highest RSRP value. In another design, the WTRU can select any of the narrow beams for which WTRU measurements have RSRP beyond a configured threshold. In another example design, the WTRU makes measurements over all the RS configurations associated to the narrow beams or over only a subset of RS configurations associated to narrow beams. This may be the case if WTRU is able to determine a suitable narrow beam from the subset of the measurements. For example, if the WTRU is configured to determine a suitable narrow beam based upon a beam with RSRP beyond a threshold, and a beam from the subset of measurements shows RSRP beyond that threshold.

In certain embodiments, determination of narrow beam may be based upon both location and measurement. In one design, a WTRU may determine a suitable narrow beam based upon the WTRU location and narrow beam RS-based measurements, where the use of WTRU location is according to one of the embodiments in this disclosure, and the use of narrow beam measurements is according to another embodiment of this disclosure.

Embodiments for determination of narrow beam CORESET 0 configuration are disclosed. A WTRU may determine to receive system information through a second beam, e.g., a narrow beam. The WTRU may be configured to receive the system information through its determined narrow beam. This may, for example, be the case when the WTRU is receiving the indication for second (narrow) beams through the SSB of the first (wide) beam. The SSB of the first beam may provide the WTRU with a set of CORESET 0 configurations associated to narrow beams.

Upon receiving the SSB of the first (wide) beam, the WTRU may determine the CORESET 0 configurations for the narrow beams and RSs configurations for the narrow beams. The WTRU may determine a suitable narrow beam according to one of the embodiments in this disclosure. he WTRU may determine a CORESET 0 configuration to receive system information (e.g., SIB1, SIB19, etc.) based upon its determined second (narrow) beam, and the received CORESET 0 configurations associated to second (narrow) beams. The WTRU may first determine a suitable CORESET 0 configuration based upon its determined narrow beam. The WTRU may then use the determined CORESET 0 configuration to receive the system information through the determined narrow beam.

Examples of SIB reception through the narrow beam are disclosed. A WTRU may determine to read the system information through a second beam, e.g., a narrow beam. The WTRU may determine to read all SIBs or some specific SIBs (e.g., SIB1, SIB19, etc.) through a second (narrow) beam based upon configuration. The WTRU may receive one or more SIBs through a second (narrow) beam where the WTRU determines the second beam for SIB reading according to any one of the embodiments in this disclosure.

The WTRU may determine to read the one or more SIBs through the second (narrow) beam based upon its determined second beam, where the WTRU determines the second beam according to any one of the embodiments in this disclosure, and based upon its determined CORESET 0 configuration, where the WTRU determines a CORSET 0 configuration to receive system information according to any embodiment described herein.

In various embodiments, the WTRU may determine to read system information through the second (narrow) beam when the satellite is transmitting the system information through narrow beams. In one example, this may be the case when the network is using wide beams for SSB transmission only, and all the system information is being transmitted through the narrow beams.

According to various embodiments, a WTRU may determine to receive signals and channels using an Rx filter which corresponds to the Rx filter used by the WTRU to receive the satellite's transmissions through the second (narrow) beam. In one example, the WTRU may use an Rx filter to receive system information through the second beam which corresponds to the Rx filter of the determined second (narrow) beam. In one example, this Rx filter may correspond to the Rx filter through which WTRU made measurements over the determined/selected second (narrow) beam.

A WTRU may detect and receive signals and channels transmitted through a second (narrow) satellite beam. The signals and channels received by the WTRU through the second beam may be one or more of the following:
SSB (or other reference signals serving to provide time and frequency synchronization for WTRUs);
SIB1 (carrying master information block, or the most basic part of system information etc.);
SIBs (e.g., other than SIB1, or all SIBs etc.);
Paging (e.g., all paging, or paging related to certain causes, e.g., SIB update, or related to emergency warning systems etc.);
All or a subset of common channels; and/or
WTRU dedicated signals and channels.

In various embodiments, the WTRU may determine one or more of the followings based upon its decoded SIB1:
Cell selection information;
Information regarding the availability and scheduling (e.g. periodicity, SI-window size) of other SIBs;
Indication whether other SIBs are provided via periodic broadcast basis or only on-demand basis;
Information for the WTRU to perform a SI request;
Serving cell configuration (e.g., DL config, UL config [UL BWP, RACH configuration, etc.], SSB position in burst, etc.);
Timers and constants for WTRU procedures; and/or
Narrow beam configuration where the contents of the narrow beam configuration are according to one of the embodiments in this disclosure.

Determination of RACH configuration (or SSB-to-RO Mapping) is now described. In various embodiments, a WTRU may determine a RACH configuration (or an SSB-to-RO mapping) to determine a suitable RACH occasion. This may, for example, be the case when the WTRU is configured/provided with more than one configurations (SSB-to-RO mappings). The WTRU may determine an SSB-to-RO mapping to select a suitable RACH resource for its RACH transmission. In various designs, the WTRU may determine a suitable SSB-to-RO mapping based upon one, or a combination of: a current time; reference timings associated to SSB-to-RO mappings; reference time ranges associated to SSB-to-RO mappings; WTRU location; satellite location and/or reference locations for narrow beams

In various embodiments, the WTRU selects a Tx beam filter for a RACH transmission. A WTRU may select a Tx filter to send a RACH transmission. The WTRU may select the Tx filter to transmit the RACH based upon its determined narrow beam, where the determination of narrow beam is according to one of the embodiments disclosed herein. In one design, the WTRU may select a Tx filter RACH transmission which corresponds to the receive (Rx) filter through which WTRU made measurements over the determined narrow beam RS (e.g., CSI-RS, or cell defining SSB, non-cell defining SSB, any other signal, etc.).

In one design, the WTRU may be provided a set of Tx filters (e.g., Tx coefficients) for different narrow beams, where the different Tx filters may be associated to reference locations of narrow beams. In one design, the WTRU determines a Tx filter to transmit RACH based upon the wide satellite beam through which it received SSB (and or other SIBs).

Embodiments disclosed herein may determine a RACH resource for the narrow beam. In one example, the WTRU may determine a RACH resource for its intended RACH transmission. In another example, the WTRU may determine a RACH resource associated to a second beam, e.g., a narrow beam. The WTRU may determine a RACH resource based upon one or more of the following items (1)-(3):
(1) The WTRU determined narrow beam, e.g., according to one of the embodiments in this disclosure;
(2) The WTRU determined SSB-to-RO mapping, e.g., according to one of the embodiments in this disclosure, while the WTRU may be provided/configured with more than one SSB-to-RO mappings; and/or
(3) The SSB-to-RO (or RACH) configuration received through a second (narrow) beam where the second beam is determined by the WTRU through location or through measurements according to one of the embodiments in this disclosure.

Transmission of RACH over a narrow beam associated RACH resource is disclosed. In the embodiments herein, a WTRU may transmit a RACH, transmit a RACH over its determined RACH resource associated to a suitable second (narrow) beam, and/or transmit a RACH over the determined RACH resource using a Tx filter where the determination of Tx filter for RACH transmission is according to one of the embodiments in this disclosure.

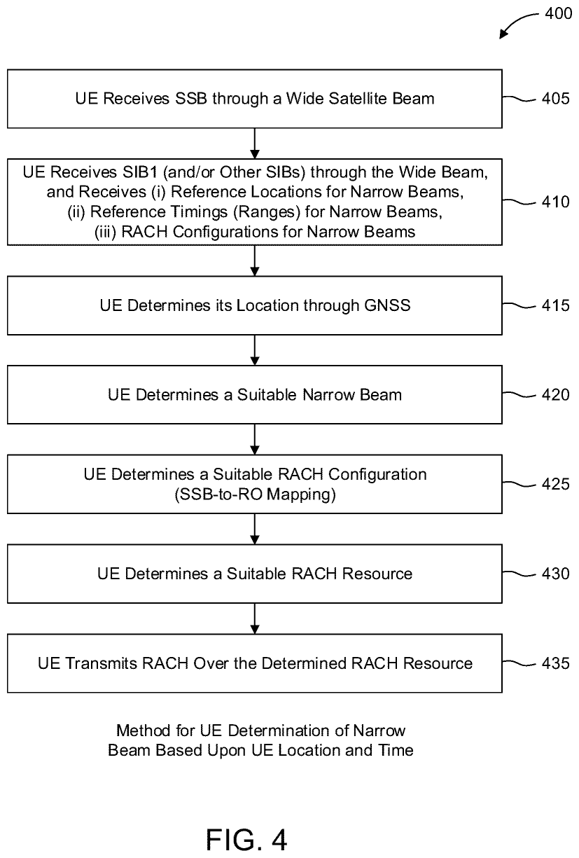

Referring to FIG. 4, a method 400 for a WTRU to perform initial access with RACH determination based upon location/time is shown according to one example embodiment. Method 400 is based on the premise that the NTN satellite is transmitting, and the WTRU is receiving, both the SSB and SIBs (e.g., SSB/SIB1/SIB19) in a wide beam and that the WTRU selection of a narrow beam is based upon WTRU location/time. In this embodiment, the received decoded SIBs provide a set of reference locations for narrow beams and several RACH configurations (or SSB-to-RO mappings) for narrow beams provided against reference timings and satellite location. The WTRU may determine a suitable RACH resource based upon: (i) WTRU location, (ii) reference locations for narrow beams, (iii) current time, (iii) reference timings for RACH configurations (or SSB-RO mappings) and/or (iv) satellite location. The WTRU may then send a RACH transmission over the determined RACH resource.

In FIG. 4 method 400, a WTRU is camping on an NTN cell and receives 405 a SSB through a first (wide) beam. Based on the received SSB, the WTRU receives 410 one or more SIBs (e.g., SIB1/SIB19) through the same (wide) beam, wherein the one or more SIBs (e.g., SIB1) provide the information including: (i) reference locations for narrow beams; (ii) reference timings (e.g. reference timing ranges) for determination of a narrow beam; (iii) several RACH configurations (or SSB-to-RO mappings); and/or (iv) an association/mapping of RACH configurations to reference timings and satellite location.

At step 415, the WTRU determines its location, e.g., through GNSS and in step 420, the WTRU determines a suitable narrow beam based upon (i) WTRU location; and (ii) the reference locations for narrow beams. Next, the WTRU may determine/select 425 a suitable RACH configuration (or SSB-to-RO mapping) based upon: (i) a current time (e.g., system frame numbers (SFNs)) which may be based upon beams/cells being earth fixed or earth moving; (ii) reference timings associated to the RACH configuration; and (iii) the satellite location.

In step 430, the WTRU determines a suitable RACH resource based upon (i) the determined narrow beam, (ii) the determined RACH configuration (or SSB-to-RO mapping). The WTRU then sends a RACH transmission over the determined RACH resource. It is noted that steps/information of method 400 may be omitted, repeated, performed in different order and/or combined with steps/information of other embodiments disclosed herein.

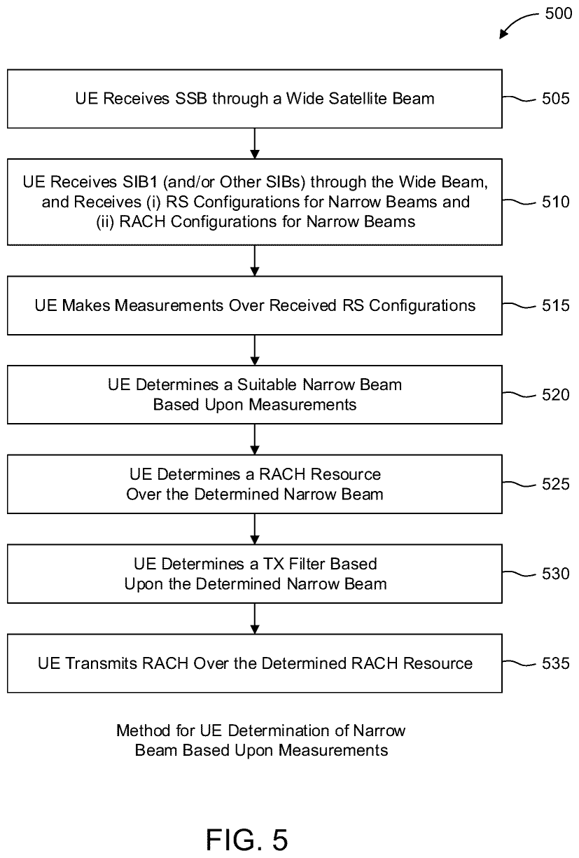

In another embodiment, referring to FIG. 5, an example solution is premised on NTN satellite wide beams transmitting the SSB and one or more SIBs, where the WTRU selection of a narrow beam is based upon measurements. In this embodiment, a WTRU detects the SSB of the wide beam and reads SIBs (e.g., SIB1/SIB19) of the wide beam. In an example, SIB1 may provide a configuration of CSI-RS (or some suitable RS) for the narrow beams within coverage of the wide beam and a CSI-RS to RACH resource mapping. The WTRU measures the CSI-RS of narrow beams and selects a suitable narrow beam (e.g., corresponding to a highest RSRP CSI-RS measurement), determines a RACH resource associated to the selected CSI-RS beam based on the mapping and sends a RACH transmission over the determined RACH resource.

In FIG. 5 method 500, a WTRU is camping on an NTN cell and receives 505 a broadcast SSB through a first (wide) beam. Based on the received SSB, the WTRU receives 510 one or more SIBs (e.g., SIB1/SIB19) through the same (wide) beam, wherein the one or more SIBs (e.g., SIB1) provide information including: (1) CSI-RS resource configurations corresponding to the narrow beams within the wide beam; and (ii) a RS (e.g., CSI-RS) narrow beam to RACH resource mapping.

Based upon the information received through SIB1, the WTRU performs 515 measurements of received CSI-RSs of the CSI-RS resources configurations corresponding to the narrow beams, and determines/selects 520 a suitable narrow beam (e.g., based on a highest RSRP). At step 525, the WTRU determines a suitable RACH resource based upon; (1) the selected CSI-RS narrow beam; and (ii) the CSI-RS narrow beam to RACH resource mapping. The WTRU may then send a RACH transmission over the determined RACH resource using a Tx filter corresponding to the selected CSI-RS narrow beam. As with other embodiments, steps/information of method 500 may be omitted, repeated, performed in different order and/or combined with steps/information of other embodiments disclosed herein.

One example benefit of this embodiment is that the WTRU/gNB sends/receives the RACH transmission with the narrow beam based Tx/Rx filter, overcoming the RACH degradation had it been based upon the wide beam.

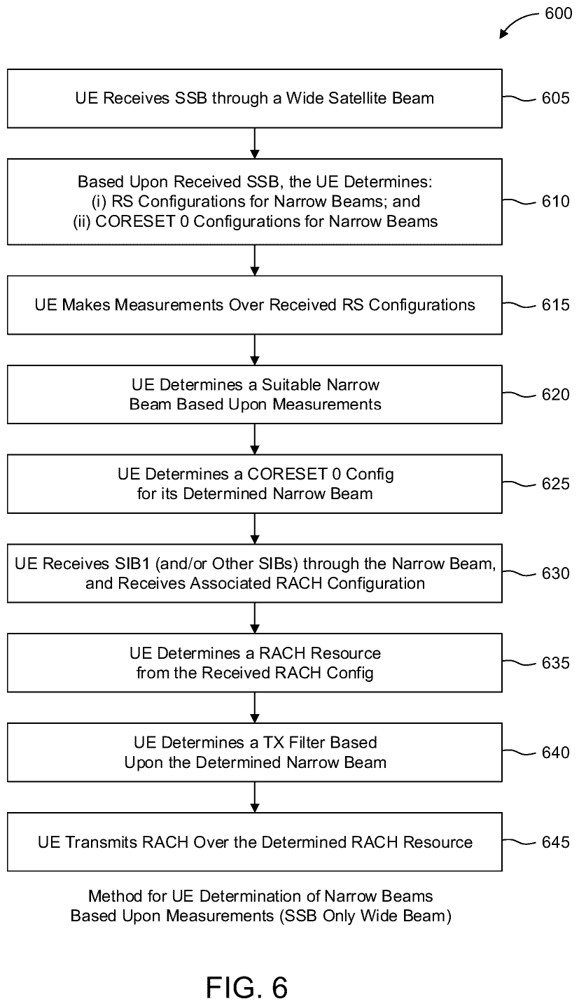

In yet a further embodiment, referring to FIG. 6, an example solution is premised on NTN satellite transmitting only the SSB on the wide beam, where the WTRU selection of a narrow beam is based upon measurements. In an example of this embodiment, a WTRU detects the SSB of wide beam, where the SSB provides the information of narrow beam CSI-RS resources and CORESET 0 configurations. The WTRU measures the CSI-RS of narrow beams and selects a suitable (e.g., highest RSRP) narrow beam. The WTRU reads SIBs (SIB1/SIB19) through the selected narrow beam to obtain the RACH configuration for the narrow beam and the WTRU sends a RACH based on the received RACH configuration.

In FIG. 6 method 600, a WTRU is camping on an NTN cell and receives 605 a broadcast SSB through a wide satellite beam. At step 610, based on the received/detected wide beam SSB, the WTRU receives information to determine information including: (i) CSI-RS configurations for the narrow beams within the wide beam; and (ii) CORESET 0 configurations for the narrow beams. In an example, the information is, for example, carried over a SSB index re-purposed bits (e.g., partial, full, DMRS initialization, PBCH payload) and/or other MIB IEs (e.g., new interpretation for PDCCH_config_SIB1 to provide CSI-RS and CORESET 0 configurations for the narrow beams within the wide beam).

At step 615, based upon the information received through the wide beam SSB and determined RS configurations for the narrow beams, the WTRU performs 615 measurements on received CSI-RSs of the CSI-RS configurations for the narrow beams, determines/selects 620 a suitable narrow beam (e.g., corresponding to a measurement resulting in highest measured RSRP).

At step 625, the WTRU determines the CORESET 0 configuration based upon the wide beam SSB and the selected narrow beam and in step 630, the WTRU reads the one or more SIBs (e.g., SIB1/SIB19, etc.) through the determined CORESET 0 configuration. Next, the WTRU determines 635 a suitable RACH resource based upon the received SIB1 (with a CSI-RS to RACH mapping) through the selected narrow beam and sends 645 a RACH transmission over the determined RACH resource using the Tx filter corresponding to the selected CSI-RS narrow beam. As with other embodiments, steps/information of method 600 may be omitted, repeated, performed in different order and/or combined with steps/information of other embodiments disclosed herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit receive unit (WTRU), the method comprising:
receiving, from a non-terrestrial network (NTN) satellite, a synchronization signal block (SSB) in a wide beam;
based on the received SSB, receiving from the NTN satellite, one or more system information blocks (SIBs) in the wide beam, to determine reference locations of a plurality of narrow beams within coverage of the wide beam, wherein the one or more SIBs indicate associated narrow beam reference timings and a plurality of random access channel (RACH) configurations corresponding to the plurality of narrow beams;
determining a select narrow beam from the plurality of narrow beams based on a current location of the WTRU and the reference locations of the plurality of narrow beams;
selecting a RACH configuration from the plurality of RACH configurations based on a location of the satellite, the associated narrow beam reference timings and a current time;
selecting a RACH resource based on the select narrow beam and the selected RACH configuration; and
sending, to the NTN satellite, a RACH transmission over the selected RACH resource.

2. The method of claim 1, wherein the location of the WTRU is determined from a global network satellite system (GNSS) or a radio access technology (RAT) positioning method.

3. The method of claim 1, wherein the plurality of RACH configurations comprise one or more SSB-to-RACH occasion (SSB-to-RO) mappings associated to one or more satellite locations.

4. The method of claim 1, wherein the current time corresponds to one of a time of detection of the SSB, a time of detection of the one or more SIBs, or a time of expected RACH transmission.

5. The method of claim 1, wherein the determining of the select narrow beam from the plurality of narrow beams based on the current location of the WTRU and the reference locations of the plurality of narrow beams comprises:
selecting a narrow beam, as the select narrow beam, the narrow beam having a reference location closest to the current location of the WTRU.

6. The method of claim 1, wherein the determining of the select narrow beam from the plurality of narrow beams based on the current location of the WTRU and the reference locations of the plurality of narrow beams comprises:
selecting a narrow beam, as the select narrow beam, the narrow beam having a coverage area including the current location of the WTRU.

7. The method of claim 1, wherein the reference locations of the plurality of narrow beams each correspond to geographic coordinates of a corresponding narrow beam central location.

8. The method of claim 1, wherein the one or more SIBs comprise at least a SIB1 and a SIB19.

9. The method of claim 8, wherein the SIB1 includes one or more of: a narrow beam configuration, a cell selection information, information of an availability and scheduling of one or more other SIBs, an indication of whether the one or more other SIBs are provided on a periodic broadcast or on a demand basis, serving cell configuration, or timers and constants for WTRU procedures.

10. A wireless transmit receive unit (WTRU) comprising:
a transceiver; and
a processor operatively coupled to the transceiver, wherein the transceiver and the processor are configured to:
receive, from a non-terrestrial network (NTN) satellite, a synchronization signal block (SSB) in a wide beam;
based on the received SSB, receive from the NTN satellite, one or more system information blocks (SIBs) in the wide beam, to determine reference locations of a plurality of narrow beams within coverage of the wide beam, wherein the one or more SIBs indicate associated narrow beam reference timings and a plurality of random access channel (RACH) configurations corresponding to the plurality of narrow beams;
determine a select narrow beam from the plurality of narrow beams based on a current location of the WTRU and the reference locations of narrow beams;
select a RACH configuration from the plurality of RACH configurations based on a location of the satellite, the associated narrow beam reference timings and a current time;
select a RACH resource based on the select narrow beam and the selected RACH configuration; and
send, to the NTN satellite, a RACH transmission over the selected RACH resource.

11. The WTRU of claim 10, wherein the location of the WTRU is determined from a global network satellite system (GNSS) or a radio access technology (RAT) positioning method.

12. The WTRU of claim 10, wherein the plurality of RACH configurations comprise one or more SSB-to-RACH occasion (SSB-to-RO) mappings associated to one or more satellite locations.

13. The WTRU of claim 10, wherein the current time corresponds to one of a time of detection of the SSB, a time of detection of the one or more SIBs, or a time of expected RACH transmission.

14. The WTRU of claim 10, wherein to determine the select narrow beam from the plurality of narrow beams based on the current location of the WTRU and the reference locations of narrow beams, the transceiver and the processor are further configured to:
select a narrow beam, as the select narrow beam, from one of: the narrow beam having a reference location closest to the current location of the WTRU or the narrow beam having a coverage area including the current location of the WTRU.

15. A method for use by a wireless transmit receive unit (WTRU), the method comprising:
receiving, from a satellite in a non-terrestrial network (NTN), a synchronization signal block (SSB) in a wide beam;
based on the received SSB, receiving, in the wide beam from the satellite, one or more system information blocks (SIBs), wherein the one or more SIBs indicate reference signal (RS) configurations for a plurality of narrow beams within coverage of the wide beam and a plurality of random access channel (RACH) configurations for the plurality of narrow beams;
performing measurements on received RSs associated with the RS configurations to determine a select narrow beam;
determining a RACH resource and a transmission (Tx) filter for the select narrow beam; and
sending a RACH transmission using the Tx filter and the determined RACH resource.

16. The method of claim 15, wherein the Tx filter corresponds to a WTRU Rx filter used to perform the measurements on the selected narrow beam.

17. The method of claim 15, wherein determining the RACH resource for the select narrow beam is based on at least one the RSs associated with the select narrow beam.

18.-20. (canceled)
